(19) United States
(12) Patent Application Publication
(10) Pub. No.: US 2004/0143475 A1
(43) Pub. Date: Jul. 22, 2004

(54) Engineering data interface and electrical specification tracking and ordering system

(76) Inventors: Mary Jo Kilburn, Cedar Park, TX (US); Kim P. Mulvey, Austin, TX (US); Stevan J. Smith JR., Azle, TX (US)

Correspondence Address: 3M INNOVATIVE PROPERTIES COMPANY, PO BOX 33427, ST. PAUL, MN, 55133-3427, US

(21) Appl. No.: 10/733,746

(22) Filed: Dec. 11, 2003

Related U.S. Application Data
(63) Continuation-in-part of application No. 10/319,035, filed on Dec. 13, 2002.

(51) Int. Cl. G06F 17/60

(52) U.S. Cl. 705/8

(57) ABSTRACT

A portable electronic engineering data interface and tracker that includes a host system which receives written or electronic engineering data from an engineering company for a construction project or subproject, transfers the information to a software program that re-formats the information to provide device or product level data for use in determining specific products, marking requirements, and making project management calculations, manages the data in a standard format and in one software package, manages revision levels and changes to engineering data from a field system shared among several entities, analyzes data and reports any changes to said data, tracks progress of the project by work completion, distributes information by means of the software using email for portability, sorts termination data by specific location, device, or system, and generates orders for products to be delivered.

This patent application is a continuation-in-part and claims the benefit of the priority of U.S. patent application Ser. No. 10/319,035, filed Dec. 13, 2002.

### TECHNICAL FIELD

The invention relates to a hardware assisted system and business method for integrating work process and design data for the customization and delivery of products and services, management of project tasks and timelines, and management of materials within construction projects.

### BACKGROUND

In the construction industry, it is common for multiple engineering drawings, blueprints and spreadsheets to contain information essential to the accurate and timely construction of the project, all the subprojects, such as electrical and mechanical projects, and their components. The industry has typically transferred this information on paper to databases, and manually to other parties involved in the business of building and managing the project, including such parties as subcontractors, vendors and suppliers, and site managers. The number of components were estimated or manually counted, then ordered, which resulted in either large expenditure of time, under- or over-estimated orders, or both. Underestimated orders required adjustments, i.e., workman time lost while awaiting new parts; overestimated orders resulted in additional paperwork, refund requests, inventory restocking charges, scrapped materials and the like.

Changes made during construction, variations in “as-built” versus plan, and transcription errors regarding such changes further exacerbate these problems. Current methods to communicate timing and quantity of parts needed include electronic changes, hand written, transcribed to printers at off-site locations, and manually loaded hand-held printers. All of these systems are inconsistent, slow and error-prone.

These problems are especially difficult in a material intensive construction subproject such as the electrical project. Hundreds of thousands of wires and cables need to be marked and/or labeled consistently. Marking and identification are critical as is installation status, system start-ups, and “as-built” modifications to use for maintenance of the installed systems. The current work processes include using a hand held device and printing marks in the field as they are needed. In many cases, some of the tags are sent out to be printed (e.g., at engraving shops). These processes cause delays and extra steps to manage.

Processes exist within the industry for project management and identification of electrical cables, wires and systems. The current systems use varying degrees of integrated databases, computer assisted design (CAD) type drawing systems, paper drawings and internal documentation systems. The problem is that these systems tend to be specific to the project manager involved with the individual project. Thus multiple projects and subprojects may be managed using different systems. The systems and work processes are not easily transferable and reside with a specific individual. This prohibits a consistent product and can hinder the timeliness and cost of the project itself.

It would be desirable to have a system that provides a solid link between contractor, subcontractors, architects, vendors, owners and others in the construction industry. An automated system and a method of doing business using that automated system has now been developed, which eliminates much of the paper shuffling, counting and recounting, and returns generated by the old systems.

### SUMMARY

An aspect of the present invention is a portable system comprising a host system, and a field system that can communicate with the host system, said portable system capable of receiving engineering information related to at least a portion of a construction project, such as an electrical subproject, from a database or spreadsheet, formatting the information into a suitable format to be used for one or more of printing identification product, preparing work packages, tracking materials used, and reporting materials used for the construction project.

An embodiment of the portable system is capable of generating orders for identification products and managing fulfillment of the orders, which may include generating a termination report and/or generating a pull card.

Another embodiment of the portable system is capable of providing remote tracking capability to verify and quantify project progress as measured by one or more of materials used and man-hours used.

Another embodiment of the portable system includes a printing system that can communicate with one or both of the host and field systems. The host and/or field system may communicate information regarding label contents, formatting, and printing sequence to the printing system.

In another embodiment of the portable system at least one label or marker ordered is for an electrical device, a cable, or an electrical termination. The labels may be delivered together with a termination report and/or a cable accessory kit.

Another embodiment of the portable system is capable of generating reports covering one or more of estimates of cable length requirements, field installation logs, the actual length of cable used, and the reel from which it was pulled.

In another embodiment of the portable system orders are generated for at least one master carton containing multiple identification products for the same construction area and level criteria for the contents of the master carton have been pre-selected.

Another aspect of the invention is a business method comprising

receiving written or electronic engineering data for a construction project or subproject and

transferring the data to a software program that organizes the data into a suitable format to be used for one or more of printing identification products, preparing work packages, tracking materials used, and reporting materials used for the construction project.

In another embodiment of the business method the formatted information can be used for one or more of making identification products according to one or more different levels, establishing marking requirements, and making project management calculations.

Another embodiment of the business method includes generating orders for identification products. The identification products are generated and/or delivered according to project milestones.

Another embodiment of the business method includes generating reports covering one or more of estimates of cable length requirements, field installation logs, the actual length of cable used, and the reel from which it was pulled.

Another embodiment of the business method includes the following:

receiving written or electronic engineering data for an electrical subproject of a construction project,

creating in a software program a unique template that translates the received data into a format understood by the user,

transferring the data to said software program to provide termination point data for use in determining specific identification product requirements, determining marking requirements, and making electrical project management calculations,

managing the termination point data for cabling, routing, and marking purposes in a common format in said software program,

managing changes to engineering data, analyzing how changes to the data effect identification products needed, and generating reports on any changes to said data, tracking progress of the project by work completion,

distributing information by means of the software using the Internet,

sorting termination data by specific area, device, system, cable, or wire,

generating orders for electrical identification products, and

integrating supply chain process flow information into the process as automated steps for ordering, processing, and fulfillment.

In another embodiment of the business method tracking progress of the project by work completion may be accomplished by tracking earned hours to calculate percentage of completion.

Another embodiment of the business method includes utilizing radio frequency identification for one or more of product ordering, product re-ordering, material management, and project tracking.

Another embodiment of the business method includes a step in which the software electronically generate invoices for products ordered and delivers the invoices via the Internet. The invoices may be sent by e-mail.

According to other aspects of the invention, identification products in various forms and combinations can be ordered using the portable system. For example, a kit containing a set of wire markers meeting specific requirements for an electrical subproject may be ordered. The markers may be printed off site and delivered in a labeled package designating the intended location of said markers. Identification products that have been ordered can be organized into at least one master carton. A master carton can include identification products for a single device or area of a construction project configured by the portable system.

As used herein, these terms have the following meanings:

1. The term “area” means a three dimensional geographical area within a construction project.

2. The terms “masterpak” and “master carton” mean a carton containing multiple products related to one device within a specific system(s) or area(s) in the project. The products may be similar, identical or totally different from one another.

3. The term “termination point” refers to data regarding the point at which an electrical connection is made.

4. The term “raceway” refers to a holder for wires or cables, such as a conduit or cable tray.

5. The term “fulfillment” means providing the products ordered, packaging them as requested and delivering them in a timely fashion to the requested location. The term “portable system” means that the system is usable at different locations including mobile locations. While the field system may contain portable hardware, the term does not mean or require that all hardware for both the host system and the field system must be portable.

6. The term “mirror dataset” means a copy of the original dataset.

7. The terms “identification product”, “tag”, “marker”, “marks,” and “label” are used interchangeably.

8. The term “level” refers to the different categories of specificity in a construction project; e.g., the following are levels of increasing specificity: area, system, device, cable/circuit, and wire.

An advantage of at least one embodiment of the present invention is the elimination or minimization of inefficiencies and slowdowns due to a mistake in carrying out tasks such as providing information for markers, determining the method of printing the markers, formatting the information to be on the markers, and printing the markers An advantage of at least one embodiment of the present invention is reducing the amount of labor required to print and organize identification products.

An advantage of at least one embodiment of the present invention is providing contractor with a more cost efficient way of labeling electrical terminations, cables, conduits, raceways, cable-trays, equipment, and instrumentation.

An advantage of at least one embodiment of the present invention is improving wire management and risk management, reducing rework, and making the as-built project archive available for the maintenance of a building.

### BRIEF DESCRIPTION OF THE FIGURES

FIG. 1 is a digital image of an interactive computer screen showing aspects of the present invention in which various categories of information can be entered.

FIG. 2 is a digital image of an interactive computer screen showing aspects of the present invention in which labels can be selected for ordering.

FIG. 3 is a digital image of an interactive computer screen showing aspects of the present invention in which a preview of labels to be printed can be reviewed.

FIG. 4 is a digital image of an interactive computer screen showing aspects of the present invention in which estimated of cable length requirements can be made.

FIG. 5 is a digital image of an interactive computer screen showing aspects of the present invention in which “pull cards” for cable installation can be generated.

FIG. 6 is a digital image of an interactive computer screen showing aspects of the present invention in which reports of installed cable can be generated.

FIG. 7 is a schematic representation of the amount of data input needed based on the wanted by the user from the portable system of the present invention.

FIG. 8 is a schematic representation of the communication flow of one aspect of the portable system of the present invention.

FIG. 9 is a schematic representation of the work process and material staging benefits provided by use of the portable system and business method of the present invention.

FIG. 10 is a digital image of an interactive computer screen showing aspects of the present invention in which the reels from which cable are pulled for a particular circuit can be recorded.

FIG. 11 is a digital image of an interactive computer screen showing aspects of the present invention in which reports of installed cable by type/area can be generated.

FIG. 12 is a digital image of an interactive computer screen showing aspects of the present invention in which reports of man hours by type/area can be generated.

FIG. 13 is a digital image of an interactive computer screen showing aspects of the present invention in which reports of cable inventory and usage can be generated.

### DETAILED DESCRIPTION

An aspect of the invention provides a portable system including a host system, a field system, and optionally a printer system. The host system typically contains a hardware component and at least one software program. The field system, and the optional printer system, share the software with the host system and include a hardware component such as a computer or personal digital assistant that can receive engineering information related to a construction project from a database or spreadsheet, format the information so that it can be used to create an overall specification and provide products and services to that specification for a specific construction project. The portable system can generate custom orders for products, manage fulfillment of the orders, and provide remote tracking capability using the computer via a PDA to verify and quantify project progress.

Another aspect of the invention provides a method of doing business creating customized orders for construction products by use of a host system which receives written or electronic information from an engineering company for a construction project, transfers the information to a software program that re-formats the information to provide data at the component level that is used in determining specific products, marking requirements and making electrical project management calculations.

In one embodiment, the method of doing business provides automated information at the “termination point” level for electrical features of the project that is used in determining specific products, marking requirements and making electrical project management calculations for electrical components and subcomponents required. The automated system manages the “termination point” data for cabling, routing, marker etc in a standard format and in one software package, manages revision levels and changes to engineering data among several entities, analyzes data and reports only “changes”, tracks progress of the project in terms of work completion and productivity, distributes information that has been reformatting by the software using email to support portability in the field, sorts termination data by specific location, device or system, and generates orders for electrical identification products to be delivered.

Another embodiment of the method of doing business selects an area, enclosure or device, groups required labels according to such area, enclosure or device and prints all labels in the group. No further data entry is required.

Another aspect of the present invention is a portable electronic engineering data interface and tracker that includes a host system which receives written or electronic engineering data from an engineering company for a construction project or subproject, transfers the information to a software program that re-formats the information to provide device or product level data for use in determining specific products, marking requirements, and making project management calculations, manages the data in a standard format and in one software package, manages revision levels and changes to engineering data from a field system shared among several entities, analyzes data and reports any changes to said data, tracks progress of the project by work completion, distributes information by means of the software using email for portability, sorts termination data by specific location, device, or system, and generates orders for products to be delivered.

Another aspect of the present invention is an electronic data interface system that is based on a mapped work process and the input of engineering data to include termination point information. In one aspect, the invention is a tool that provides a standard format for collecting, filtering, and organizing data; generating sequences of data for identification products; engineering revision communications, material and workflow customization; detailed project management tracking and analysis; and material management and trending as related to the construction side of a particular project. This is possible through the use of product level, or for electrical projects “termination point” data essential for material estimating and specifications, progress reporting, trending analysis and electrical identification.

Another aspect of the invention provides for the collection of information, e.g., from the engineering design company, that describes the electrical design data for both the power and instrumentation portions of a construction project. This type of information pertains to, e.g., the installation of raceways, devices, identification materials and electrical termination and the generation of records and reports based on the receipt and/or input of the design information. Another aspect of the invention provides a method for collecting installation dates, actual lengths of raceways and cables installed, project notes, field design changes. Another aspect of the invention provides marker formatting, ordering, and printing. Another aspect of the invention facilitates organizing work packages and cable management. Another aspect of the invention provides these functions along with performing engineering calculations, and running data queries for tracking and work productivity.

Other aspects of the invention combine two or more of the previous aspects. In particular, one aspect provides the combination of all of the previous aspects in one integrated system. Combining these aspects can provide increased productivity, accurate tracking and reporting of materials used, efficient preparation of work packages and printed labels, and improved cable management.

By more effectively collecting data including termination data and managing the marking process, aspects of the invention will allow project managers to focus on the project and not on the task of printing and organizing markers.

Physical System/Software

The physical system has at least two interfacing components: a host system, a field system, and optionally a printing system. The systems are based on software that create the portable system including the host, field, and printer systems. The software may be licensed to the user, label printer, and anyone else who needs to use it to complete the project.

The host system may comprise a master database and can be the central hub for data transfers. It will typically comprise at least one software program and at least one hardware component. The host system can have interfaces for a processor, database, administrator, user, manufacturer, printer, etc. The host system can contain records of all projects entered onto the system. The field system can be a distributed database in a remote location. It will typically comprise a hardware component such as a computer or personal digital assistant. The field system will typically be designed to be used by a contractor and engineer. The printer system is an interface database for receiving print jobs, including information that needs to be printed; printing information, including formatting, font size; printing labels; and providing print project status.

Host System

Engineering data is input into a host system directly or via the field system. Data may be entered into the field system using a keyboard, point-and-click, or both, by, data base entry (text), or bar code entry. Data my be input manually, but is preferably transmitted electronically, e.g., via a disk or e-mail, preferably in the form of a spreadsheet.

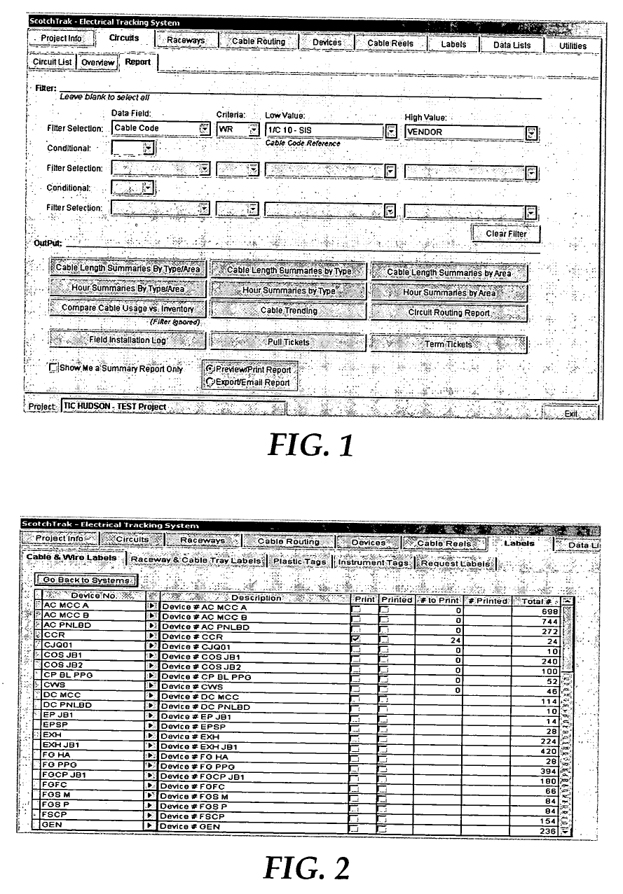

The host database can allow the design, implementation, and maintenance of customer-specific templates. For example, various data category can be established. Each category may have different alpha-numeric identifiers and sequences. The categories of information can be presented in a controlled, consistent manner using dropdown menus, check boxes, and the like. This is illustrated in FIG. 1, which is a data entry screen of the field system. In this manner, the user is forced to enter data from a controlled vocabulary or controlled set of selections. However, the template can be customized to use the unique terminology of the user.

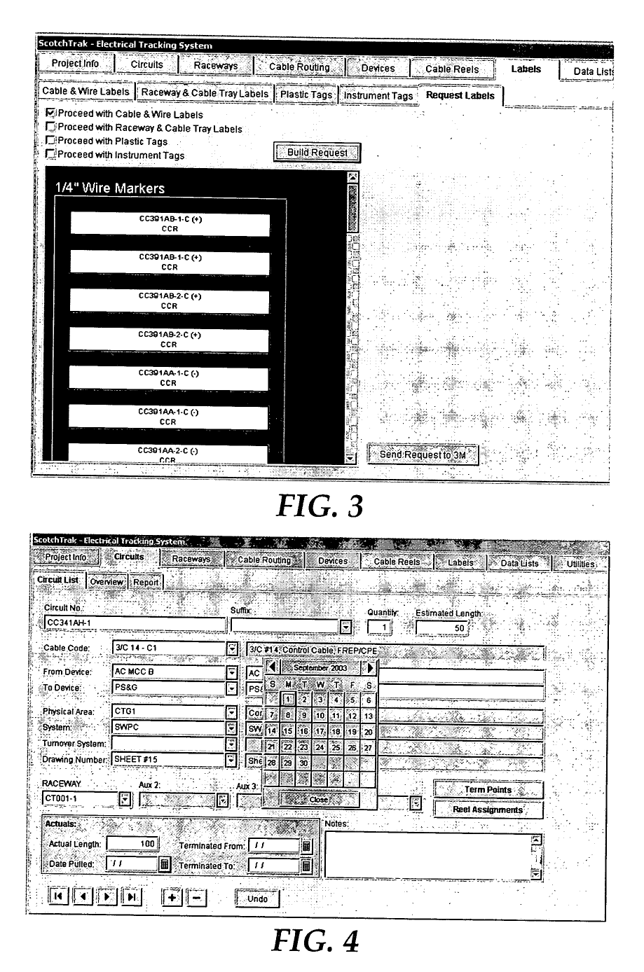

Information from different identification categories will populate a label screen, as shown in FIG. 2. This information can be printed on labels to convey specific information regarding locations of terminations. For example, FIG. 3 shows a screen with a preview of formatted labels. On the first label, “CC391AB” may refer to a circuit number, “1-C(+)” may refer to a termination point, and “CCR” may refer to a device.

The host system can create a template based on the unique language/configuration of the user's data and can format the data per the construction project workflow process. For example, the host system can set up a template for series of pulltags, wiremarkers, cablemarkers, tray tags, equipment tags, and any other type of identification tags that are needed for a particular construction job. Information required from the customer may include cable specifications, circuit and term schedules, and product specification for identification products, such as type of tag, fields and identification series numbers, print font and size, etc.

Examples of categories of information that may be loaded and tracked in the system include the following:

Circuit Information such as Circuit Identification Number, Circuit Identification Suffix (if used), Multiple Cables, Estimated Design Length, Cable Design Information, Electrical Devices Involved, Physical Location of the Circuit, System or Service that the Circuits are associated with, Turnover System Information, Drawing Number Circuit is shown on, and User Defined Information;

Raceway Information such as Raceway Identification Number, Raceway Type or Makeup, Physical Location of the Circuit, System or Service that the Circuits are associated with, Turnover System Information, Drawing Number Raceway is shown on, and User Defined Information;

Circuit Routing Information such as Raceway Routing for each Circuit, and Sequentially Ordered from a Point-to-Point basis;

Electrical Equipment such as Equipment Identification Number, Equipment Type or Makeup, Physical Location of the Equipment, System or Service that the Equipment is associated with, Turnover System Information, and Drawing Number Equipment is shown on;

User Defined Information such as Turnover Systems, and Custom Identifiers as Needed;

Wire Management such as Wire Reels based on Cable Type, Reels tagged by a Unique Identifier, Inventory System, Forecasting of Wire Usage based on Historical Data (actuals), and Pre or Post Assignment of Wire Reels for circuits; and

Installation Tracking such as Circuit Tracking, Raceway Installation Tracking, Equipment Installation Tracking, All Actual Lengths or Quantity as Installed, Provide update of Wire Inventory, and Reporting Needs of the Customer.

The host systems holds all archived data and manages any revisions or changes that are made to the data by any one of many involved parties such as the owner, an engineer or a contractor. Additional or modified data may be input directly into the host system, or may be submitted via the field system. Any time that data is entered or changed, a report can be sent to the user to validate that the data loaded into the system is complete and accurate. Approval (written or verbal) from the user can be required before the database is finalized.

The records generated based on the collected information may be stored within a database, where it may be retrieved and used to generate reports. The information also may be useful to project managers for tracking the progress of termination work orders. The system can provide reports indicating how changes, such as design changes, will impact what has already been installed including providing information on what additional materials will be required to accommodate a change or correction. The reports are exportable and may be delivered to the project managers or others via the computer network for schedule status and tracking. In one embodiment, the reports may be generated and delivered automatically to the project manager. The reports may be delivered via e-mail as an attachment or as a link to a web page. The reports may be in the form of word processing documents, spreadsheets or HTML or XML documents. Queries and reports can be created, for example by using a business intelligence software program available under the trade name CRYSTAL REPORTS from Crystal Decisions, Palo Alto, Calif., so that the construction company's logo can be on reports sent to the customer. In addition to reports, the system can generate invoices for products ordered. The invoices can be generated electronically and delivered via the Internet, including via e-mail.

Field System

The field system is designed specifically for the construction process and is portable. The system can operate on a 32bit operating system such as that available under the trade name WINDOWS, from Microsoft Corporation, Redmond, Wash.; software available under the trade name WINDOWS is owned and developed by Microsoft Corporation. Useful versions of operating software available under the trade name WINDOWS from Microsoft Corporation, include WINDOWS 95, WINDOWS 98, WINDOWS ME, WINDOWS NT, WINDOWS 2000, and WINDOWS XP Professional or WINDOWS XP Home. These are compatible with the system, which will also migrate to Apple Computer Inc. operating system Mac Native, if preferable. Hard drive space of 20 megabytes or greater is adequate for use of the system. Other suitable operating systems may include Unix and Linux, personal digital assistants (PDA)s based on a Palm, Windows CE, or similar operating system, an interactive kiosk, which may have a touch-screen display, Internet-equipped wireless telephones, and other Internet devices.

The field system may also be used to generate pull cards, termination cards (to and from), installation logs and termination sheets by device. This is in addition to reports and queries that can be run. These documents can be used to aid the work process, the electrical foreman or superintendent will pass these documents to the electrician or installer.

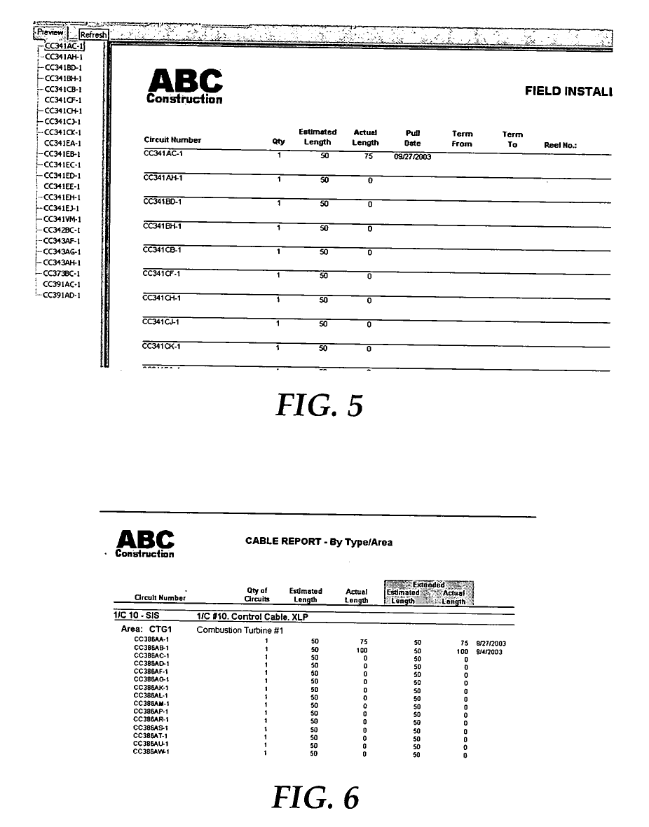

The system also allows the user to manage and keep track of day-to-day, installations, material usage, and percentage of job completion. For example, estimates of cable length requirements may be recorded on the system, as shown in FIG. 4. When cables are being pulled, a field installation log can be generated that will list all cables that will be pulled through a particular raceway. A sample field installation log is shown in FIG. 5. This information can be printed in the form of “pull cards,” which will tell the installer all the cables that need to be pulled for the raceway. When cables are installed, the actual length of cable used, and the reel from which it was pulled, may also be recorded and the information can be generated in report format, as shown in FIG. 6. This cable/wire tracking and management capability helps prevent wire and cable overrun, emergency runs, and rework.

The field database may provide the users with lists of permissible category selections for data input based on the design engineering company's database. This preloaded information may include designations for area, system (e.g., AC), cable and raceway, etc. A string of designations indicate the location of the item to be labeled.

The field database may be activated on a project basis by means of a time sensitive password. In other words, the field system will cease to accept specified (or all) changes or information after the password, or a specific time period, has expired. This will allow the customer to keep an archival copy of the information, but will prevent the reusing the software for a different project.

The field system may include the following features:

User Set-up;

Assigning System Designation to Circuits;

Assigning Turnover System Designation to Circuits; Ordering Product (Labeling of all types); Data Input for Project Tracking, including Circuit Installation—Cables Pulled, Circuit Installation—Wires Terminated, Raceway Installation, Electrical Equipment Installation, and Cable Reels Received and Pulled From;

Running reports, including Circuit Reports, Raceway Reports, Circuit Routing Reports, Electrical Equipment Reports, Wire Management Reports, and Misc. Support Reports; and

Data synchronization including To the Host, From the Host, Label Requests, and Label Status.

Printing System

Printing and label assembling services can also be provided. The printing may be conducted using the host or field system or a separate printing system may be included in the portable system. When the printing system is used, the printing and label assembling may be done by a third party, e.g., a label-making company. The label making company could be under contract with the entity controlling the host system or the entity controlling the field system. Orders for labels may be placed by the entity controlling the host system or the entity controlling the field system.

The printing system will contain software that formats and prints data in the database on marker labels. The software will typically print the tags according to system, device, or cable, that all required the same size and type of tag. The tags may then be sorted and grouped as required for customized work packages. Alternatively, the printing system may sort and print the data according to area. However, this method of printing may require frequently changing the type of tags on which the information is being printed. If this method were used, the software preferably provides an indication that a new type of tag needs to be placed in the printer and it preferably stops the printing to allow the change to be made.

The host, field, and printing systems are linked such that they can be synchronized. This will allow the transfer of information and program revisions from one system to another. Modifications and improvements to the software can be electronically sent to the field and printing systems.

Customer Input Value Pyramid

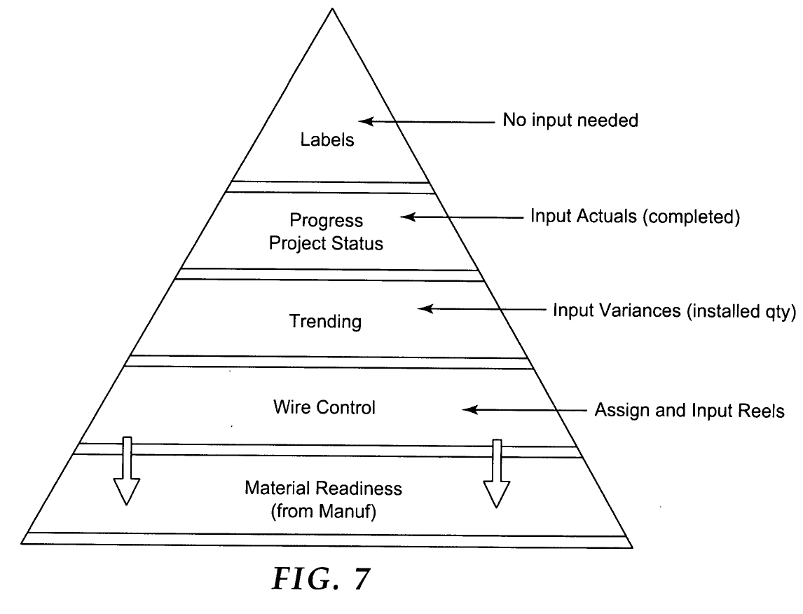

The individual customer determines the level of input for each project and therefore the level of return that can be achieved from the system. As shown in FIG. 7 the customer can order customized electrical identification products to be delivered in a work process format by merely selecting; e.g., clicking on a box within the software, indicating the system marks and labels to be printed (“Labels” at the top of the FIG. 7 pyramid). As seen in the figure, no input is needed for this level of return. If the customer wishes to input information, he can input (or “check”) that certain work tasks have been completed; the entire electrical project will have progress and status reporting available (Progress Project Status in FIG. 7). If the customer inputs “actual” installed lengths and quantities as opposed to the earlier engineering estimates, i.e., variances, project specialty and general material trending will be available (Trending in FIG. 7). This type of information will also provide forecasting and material readiness capabilities for manufacturers and distributors (Material Readiness in FIG. 7). If numbers are assigned to cable and wire reels, and the customer inputs that information into the software, a material and wire control system will be in place (Wiring in FIG. 7). By the implementation of three easy steps the project can be better managed through the use of accurate marking, project progress and status, material trending and control.

Communication Flow

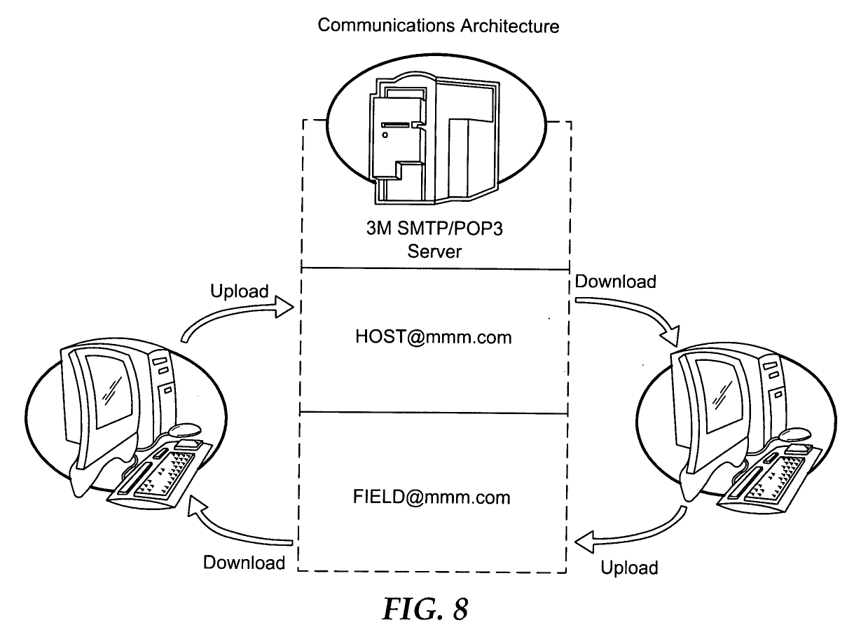

FIG. 8 is a schematic representation of the communication flow in the system. Communication of revisions between the “field” data and the previous “engineering” data will be managed via the host system. Communications can take place via a SMTP/POP3 server platform through email synchronization. A mirror copy of each dataset resides within the database, and all updates uploaded in the field are downloaded into the server, (marked “upload” into the field system on FIG. 8), and are then downloaded into the host server and are coded for change. The details and receipt of the updates are verified and confirmed before the mirror datasets are updated. As shown in FIG. 8, the host will then download those updates back to the field. A transfer impact and report log will provide information regarding non-critical or anticipated changes, critical changes or inventory or identification impacts. All changes are date and time stamped. The host system can also communicate changes to the printing system.

Access to the host, field, and printer system may be controlled by security means such as user identification and passwords. In addition, in some embodiments it may be desirable to control the level of access that a user has. This may also be accomplished with security means such as user identification and passwords.

Material and Workflow Customization

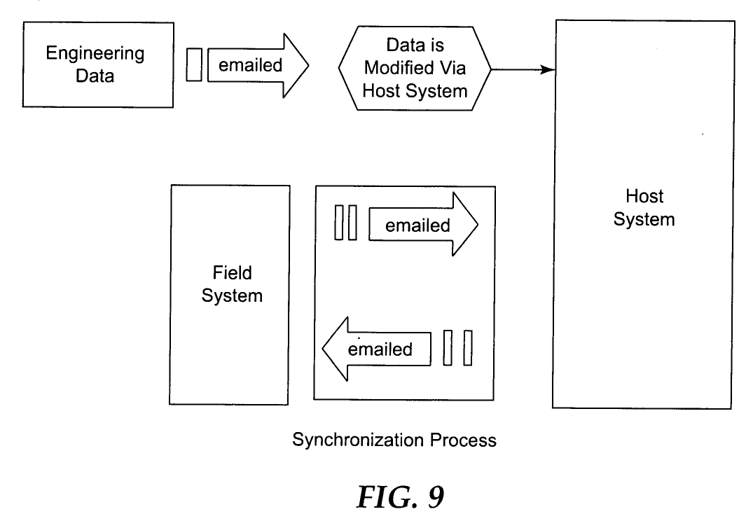

FIG. 9 is a schematic representation of the work process and material staging benefits provided by use of the portable system and business method of the invention.

The user can order identification materials, input actuals, and installation dates for project tracking and trending, synchronize with the host system for revision updates and data transfers. The “identification” part of the process defines the product specifications to be used for conduit, raceway, equipment, instruments, wires, cables, safety signs, etc. and determines the method of printing, format, and information to be printed and how those tags will be distributed relative to the work process and schedule. Engineers generate designs (Engineering data on FIG. 9); engineering data is then modified from the formats into a usable template that can be based on the user's unique methods of carrying out the construction job, within the host system. As shown in the figure, updates are emailed between the host system and the field system. For electrical projects, data and tools within the system provide specifications for specific products types required for electrical identification and termination needs. This methodology includes ordering and printing samples for approval, calculating material quantities and researching the scope and then pricing the project via the described system. The time and effort required to sort through the data to determine the information to be printed, the organization and logistics of ordering and printing materials and then staging at the devices will be drastically reduced.

The project data is converted to a field version via the unique template. This version is provided to the customer, which includes the engineering data and the software tool to be used in the management of the construction process and its assets. The system is portable, can be run remotely, and can be updated via the synchronization process described above.

An aspect of the invention provides a method for doing business that will sort product information for the various projects system, device, area, or other entered criteria for the specific workflow process of that project. For example, information can be sorted to show all identification products, as well as cable lengths and accessories that are needed to install a particular cable tray and all the wires that connect to it. For electrical projects this product information (cable ID, wire ID, equipment ID, conduit and tray ID), is sorted by system, device, area, cable etc. Products are ordered, printed, delivered and staged at the construction site via the selections from the customer. For electrical projects the customer will choose the marker sorting requirements (area, system, device) and will place the order for parts and services.

Information may be contained in radio frequency identification (RFID) tags that may be attached to the markers. The tags may contain identification information, which can be scanned. The scanned information can be used to determine where the tag is located, whether it has been installed. The use of RFID tags can assist in product ordering, product reordering, material management, and project tracking. This information can be transmitted to the field system, e.g., with a scanner, to update the status of the installation progress. The information may further be transmitted to the host system.

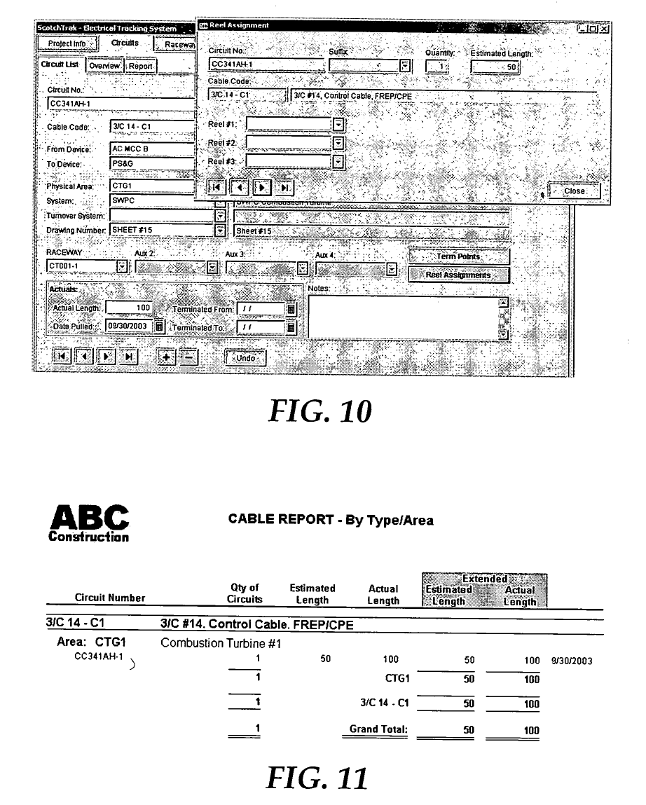

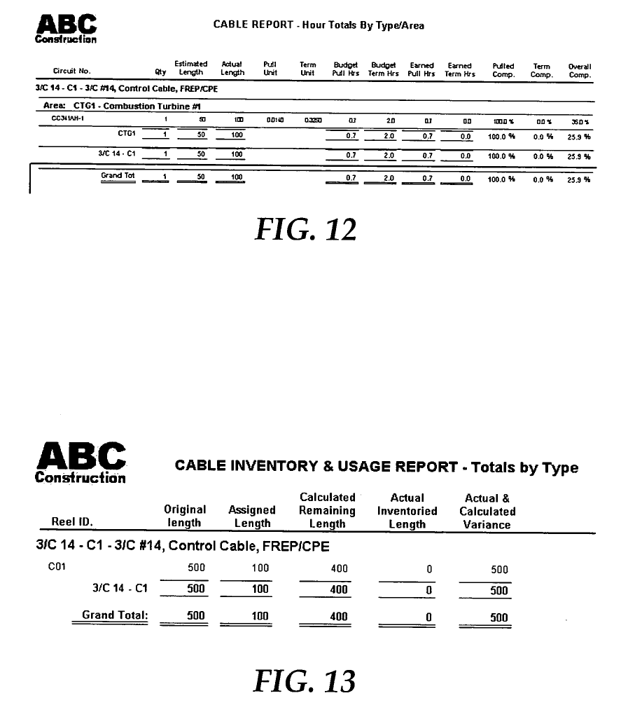

The unique configuration of the data provides the basis for detailed project management, and materials trending, and reporting. Managing information regarding earned hours, cross sectional analysis, etc. can all be accomplished through the detailed database information based on industry standards and specifications for cables and equipment. An aspect of the invention allows for cable management by recording the reel used to provide cable for a particular circuit, as shown in FIG. 10. Information can be reported in different forms. For example, FIG. 11 shows a report of Cable Length Summaries by Type/Area. FIG. 12 shows a report of Hour Summaries by Type/Area. FIG. 13 shows a report of cable inventory and usage. Work completion, as-built changes, etc. can be communicated via the synchronization process from a PDA to the field system and from the field system to the host system. The field system becomes an “as-built” configuration copy of the project itself and may be used for maintenance functions. The as-built configuration copy can help pinpoint future changes that may affect design, materials, or identification products. The ability to rebuild portions of the site systems after fire or damage, troubleshooting capability and routine maintenance tracking are all key attributes of having the completed project data. The system may be used to provide customized work packages. A customized work package is a kit or collection of various types of articles that are needed to complete an area of a project. For example, for a connection that is being made in a power system between a motor and motor control, a customized work package may include a motor connection kit, lugs, hardware, and custom labels for that specific portion of the system. For a connection between an instrument and control panel, a customized work package may include a termination report/log, pull cards, termination cards, cable accessory kit, cable tags, and wire marks, all of which may be organized by device, e.g., air conditioner, boiler, and the like. The pull cards, termination cards, and the like may be printed on water-resistant, non-tearing paper so they cannot be damaged by field conditions.

This description is not meant to be limiting as variations can be readily made by one of skill in the art, and the scope of the invention is solely that which is defined by the claims.

What is claimed is:

1. A portable system comprising a host system, and a field system that can communicate with the host system, said portable system capable of:
receiving engineering information related to at least a portion of a construction project from a database or spreadsheet, formatting the information into a suitable format to be used for one or more of printing identification product, preparing work packages, tracking materials used, and reporting materials used for the construction project.

2. A portable system of claim 1 being further capable of generating orders for identification products and managing fulfillment of the orders.

3. A portable system of claim 2 wherein managing fulfillment of the orders comprises generating a termination report.

4. A portable system of claim 2 wherein managing fulfillment of the orders comprises generating a pull card.

5. A portable system of claim 1 being further capable of providing remote tracking capability to verify and quantify project progress as measured by one or more of materials used and man-hours used.

6. A portable system of claim 1 further comprising a printing system that can communicate with one or both of the host and field systems.

7. A portable system according to claim 1 wherein the host or field system communicates information regarding label contents, formatting, and printing sequence to the printing system.

8. A portable system according to claim 1 wherein said at least a portion of the construction project is an electrical subproject.

9. A portable system according to claim 2 wherein at least one label or marker ordered is for an electrical device, a cable, or an electrical termination.

10. A portable system according to claim 9 wherein said at least one label is delivered together with a termination report.

11. A portable system according to claim 9 wherein at least one cable label is delivered together with a cable accessory kit.

12. A portable system according to claim 2 wherein orders are generated for at least one master carton containing multiple products for the same construction area, wherein level criteria for the contents of said master carton have been pre-selected.

13. A portable system of claim 1 being further capable of generating reports covering one or more of estimates of cable length requirements, field installation logs, the actual length of cable used, and the reel from which it was pulled.

14. A business method comprising
a) receiving written or electronic engineering data for a construction project or subproject and
b) transferring the data to a software program that organizes the data into a suitable format to be used for one or more of printing identification products, preparing work packages, tracking materials used, and reporting materials used for the construction project.

15. A business method of claim 14 wherein the formatted information can be used for one or more of making identification products according to one or more different levels, establishing marking requirements, and making project management calculations.

16. A business method of claim 14 further comprising generating orders for identification products.

17. A business method of claim 14 wherein the identification products are one or both of generated and delivered according to project milestones.

18. A business method of claim 14 further comprising generating reports covering one or more of estimates of cable length requirements, field installation logs, the actual length of cable used, and the reel from which it was pulled.

19. A business method according to claim 14 comprising:
a) receiving written or electronic engineering data for an electrical subproject of a construction project,
b) creating in a software program a unique template that translates the received data into a format understood by the user,
c) transferring the data to said software program to provide termination point data for use in determining specific identification product requirements, determining marking requirements, and making electrical project management calculations,
d) managing the termination point data for cabling, routing, and marking purposes in a common format in said software program,
e) managing changes to engineering data, analyzing how changes to the data effect identification products needed, and generating reports on any changes to said data,
f) tracking progress of the project by work completion,
g) distributing information by means of the software using the Internet,
h) sorting termination data by specific area, device, system, cable, or wire,
i) generating orders for electrical identification products, and
j) integrating supply chain process flow information into the process as automated steps for ordering, processing, and fulfillment.

20. A business method of claim 19 wherein tracking progress of the project by work completion is accomplished by tracking earned hours to calculate percentage of completion.

21. A business method of claim 19 further comprising utilizing radio frequency identification for one or more of product ordering, product re-ordering, material management, and project tracking.

22. A business method according to claim 19 further comprising a step in which the software electronically generate invoices for products ordered and delivers the invoices via the Internet.

23. A business method according to claim 19 wherein said invoicing is sent by e-mail.

24. An article comprising a kit containing a set of wire markers meeting specific requirements for an electrical subproject ordered by the system of claim 2, said markers being printed off site and delivered in a labeled package designating the intended location of said markers.

25. An article comprising a group of identification products selected and ordered by the system of claim 2.

26. An article according to claim 24 wherein said products are organized into at least one master carton.

27. An article comprising a master carton including products for a single device or area of a construction project configured by the system of claim 1.
